(19) United States
(12) Patent Application Publication
(10) Pub. No.: US 2003/0212630 A1
(43) Pub. Date: Nov. 13, 2003

(54) Method and apparatus for payment of bills and obligations by credit card

(76) Inventor: Andrew Kahr, San Francisco, CA (US)

Correspondence Address: GLENN PATENT GROUP, 3475 EDISON WAY, SUITE L, MENLO PARK, CA, 94025, US

(21) Appl. No.: 10/111,432

(22) PCT Filed: Dec. 8, 2000
(86) PCT No.: PCT/US00/33144

(30) Foreign Application Priority Data
Dec. 10, 1999 (US) 60172702

(51) Int. Cl. G06F 17/60

(52) U.S. Cl. 705/40

(57) ABSTRACT

A method and apparatus for payment of bills for a customer or payor of bills by channeling the borrowings to two or more major cooperating lenders with large credit charge volume is disclosed. The invention allows the presence of a transaction delivering entity to deliver debit transactions at no cost to the merchant or the payee. According to the invention, the transaction delivering entity includes either the licensee of the invention or any bill paying service. The method involves the customer's card service requesting bill payment service from the transaction delivering entity. The transaction delivering entity arranges directly with one or more of the cooperating lenders without charging a fee to the customer.

### TECHNICAL FIELD

The invention relates to a method and apparatus for payment of bills for a customer or payor of bills by channeling the borrowings to two or more major cooperating lenders that have a large credit charge volume. The method allows the presence of a transaction delivering entity to deliver debit transactions at no cost to the merchant or the payee.

### DESCRIPTION OF THE PRIOR ART

In the prior art, a customer paid bills by charging them to a credit card account only if the payee, to whom the payment is due, consented to such a transaction. In most circumstances, for instance, in the case of utility bills and mortgage payments, the payee typically does not consent to such. That is because the prior art technique entailed a cost to the payee. The cost to the payee often has been as much as 2% of the amount charged. This cost is a result of a fee collected by clearing organizations, such as Visa USA or MasterCard, through their interchange systems. In the absence of payee's consent to accepting a fee, which diminishes the actual full amount, the customer or the consumer must pay by cheque or other means rather than by credit card. Hence bill payment services, using the prior art, are limited to funding bills from deposits or investments and not, in general, by charging them to credit card accounts.

Also in the prior art, the customer paying the bills must obtain authorization to increase their credit limit to pay the bills, such credit limit is usually limited to a fixed amount that is enforced by the financial institution that issues such credit cards. There has not been a flexible management of credit lines by the clearing organization, such as Visa USA or MasterCard, as debits are generated. Due to the rigid management of credit lines, the customer is sometimes limited in his payment of bills using credit cards.

### SUMMARY OF THE INVENTION

The invention, compared with other bill payment services, allows immediate certainty of good funds through authorization and permits the customer to borrow to pay his bills. The invention facilitates channeling of borrowings to major cooperating lenders and allows the flexible management of credit limits as debits are generated. These unique advantages, applicable to any payments due by a customer to any payee, distinguish the invention dramatically from pre-existing art.

In particular, the invention pertains to a method of bill payment and includes a community of customers or payors, merchants or payees, one or more cooperating lenders, and a transaction delivering entity, such as a bill paying service.

The transaction delivering entity arranges with one or more cooperating lenders for delivering debit transactions from a customer credit card to the cooperating lenders and for extracting appropriate fees from said cooperating lenders. The payment of bills is limited to customers with total debits in excess of a specified size that are advantageous to the cooperating lenders.

According to the invention, the transaction delivering entity comprises any bill paying service. The method involves the customer's use of a card service in requesting the bill payment service from this transaction delivering entity. The transaction delivering entity arranges for payment of the bill directly with one or more of the cooperating lenders without charging a fee to the customer. The transaction delivering entity provides for a bill paying service on authorization from the customer. The customer can authorize the transaction delivering entity directly with information as to the amount paid, timing, source, destination, card account number, and any accompanying information.

If the transaction delivering entity determines that the card account does not have credit available to cover the transaction and if the customer does not authorize increasing the credit limit on one or more cards, then the transaction delivering entity notifies the customer of it's inability to cover the transaction.

If the transaction delivering entity determines that the card account does not have credit available to cover the transaction and if the customer's credit report does not match the criteria of at least one of the cooperating lenders, then the transaction delivering entity notifies the customer of it's inability to cover the transaction.

If the transaction is covered through increasing the credit limit, then the transaction delivering entity imposes appropriate transaction fees on the cooperating lenders. If it is possible to complete the transaction, then the transaction can be paid electronically or by paper money.

The presently preferred embodiment of the invention applies, for example, to payment of mortgage bills by a customer using credit cards. Transaction delivering entities arrange for one or more card issuing entities to deliver debit transactions from the customer to the card issuing entities without imposing fees on the merchant or the payee.

### BRIEF DESCRIPTION OF DRAWING

FIG. 1 is a flow diagram of a method for the payment of bills and obligations using a credit card.

### DETAILED DESCRIPTION

In conventional methods of conducting merchant transactions, bills could be charged to a credit card account only if the merchant or the payee to whom the bills are due consented to such a transaction. The payee usually has to entail as much as 2% of the payment if the payment was charged to a credit card in the prior art. This is because of the interchange fee collected by clearing organizations, such as Visa USA or MasterCard, and paid wholly or partially to the financial institution which issues such a card. In the absence of payee's consent to accepting the fee, which diminishes the full amount owed to them, the customer has to pay by cheque or other means rather than by credit card. Hence, bill payment services using prior art were limited to payments from deposits or investments and, in general, by charging them to credit card accounts.

This invention avoids imposing any reduction of the amount due on the payee as interchange fees when bills are paid by credit cards and therefore makes it possible for bill payment services to charge amounts to credit cards without the need to consent with the payee.

The reason that this invention is possible is because the invention exploits the few cooperating lenders of cards who have a high concentration of charge volume. It takes advantage of the fact that top cooperating lenders are increasingly willing to pay for debit volume for which they receive no interchange and are willing to take balance transfers at no fee. Some of the top cooperating lenders even offer concessionary rates for transfers for the life of the balance. The reason the top cooperating lenders practice this marketing technique is because they make money from a large merchant base despite the fact that they do not make money from interchange fees charged to customers.

The method involves a transaction delivering entity, (herein after called ‘license’) that arranges directly with a multiplicity of major cooperating lenders who are also card issuing institutions (herein after called ‘cooperating lenders’) for delivering the debit transactions directly to them at no fee or for a fee paid by the customer. The licensee arranges directly with two or more of such card issuing institutions, which together issue cards accounting for more than 80% of total bank credit charge volume in the U.S., to deliver debit transactions directly to the cooperating lenders at par (that is, with no fee), or with a fee to be paid by the cooperating lenders, rather than to the cooperating lenders.

Depending on the cooperating lenders, this arrangement may be limited in various ways. For instance, it may be limited to customers with particular cardholder characteristics, or to total debits in excess of a specified minimum size. Particularly, in the case of transactions delivered directly to the cooperating lenders, the cooperating lenders may also impose fees on the customer, such as cash advance or balance transfer fees, in accordance with its existing agreements with the customer.

The method also involves the licensee obtaining the bills directly from the customer by any communication medium, such as the phone, computer communication, or such. The customer directs the licensee as to the amount to be paid, timing, destination, accompanying information, and source. The customer also provides this licensee with card account numbers.

The licensee, in return, arranges to pay bills for customer, either directly or through contractors, offering to charge these bills either to credit card accounts or to deposit or investment accounts, as the customer may from time to time specify. The licensee pays the bills and charges the amounts to card accounts at cooperating lenders in accordance with its agreements with cooperating lenders and with instructions from the customer. If the licensee incurs fees through the interchange system, the cooperating lenders refunds the fee extracted by this system to the licensee.

Alternately, and in the preferred embodiment, the invention facilitates the use of credit cards, when there is sufficient debit volume by directly interfacing with the cooperating lender's processing system. Bills may be paid only when the licensee is sure that charges to cooperating lenders will be honored, i.e.; upon authorization by the cooperating lenders.

It is also possible through this invention that additional credit can be obtained by the licensee, or that credit on new card accounts can be obtained automatically by customers, subject to conditions established by cooperating lenders and communicated to customer by licensee as required by law.

The invention allows immediate certainty of good funds through authorization and permits the customer to borrow to pay his bills. The invention also facilitates channeling of borrowings to major cooperating lenders and the flexible management of credit lines as debits are generated.

Because all the banks may or may not take all the transactions, for small volume operation, the transactions are initially put through Visa or MasterCard and the cooperating lenders bank refunds the interchange fee to the licensee. The customer can pay some bills from deposit accounts and others from a credit card. Using credit reports or tapes from cooperating banks, the licensee decides which transactions qualify for charging to the major cooperating lenders. The licensee authorizes everything for 100% certainty of payments. The transactions are then directly channeled, instead of to Visa or MasterCard.

In another embodiment of the invention, any bill paying service unit, such as Intuit, or Check Free, can take care of debits, credits, functionality of broad gauge payment services and issuing a lot of payment checks. Such services also include handling customer bills for variable payments in the mail.

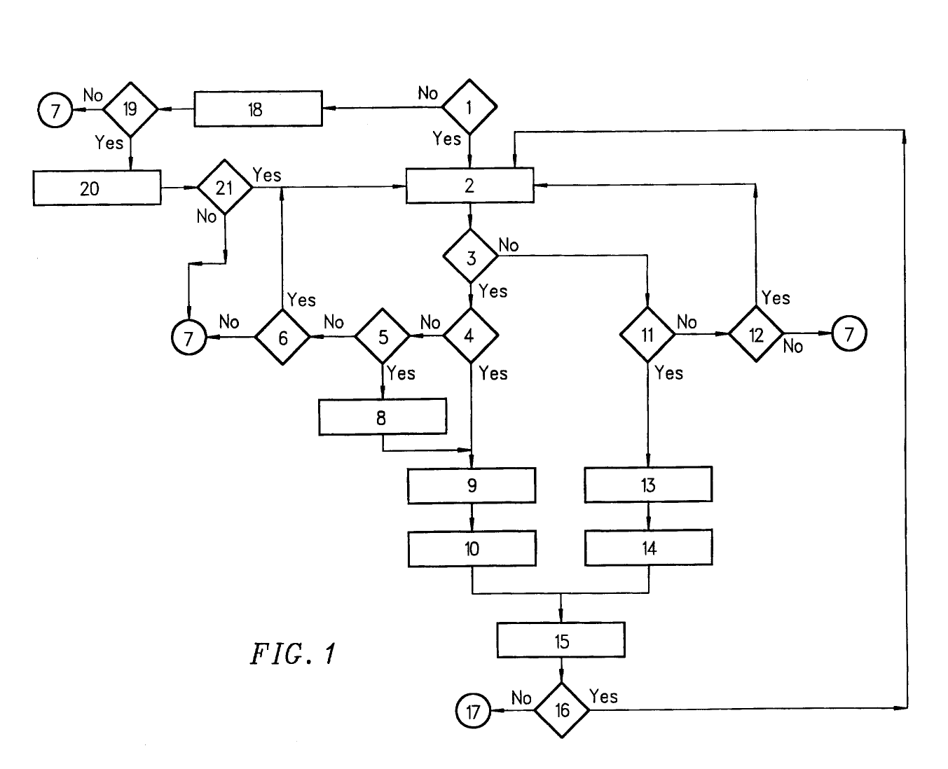

FIG. 1 is a flow diagram which illustrates a presently preferred embodiment of the invention. In the herein described invention, the licensee determines if the customer's card cooperating lenders have negotiated acquisition of debits from one or more cooperating lenders, which are also cooperating lenders of credit cards (Step 1). If the customer has authorized payment on more than one card, the most advantageous of debit transactions to the licensee is determined in terms of large volume of debit transaction (Step 2). If the cooperating lenders of the card clears with the licensee directly, then further steps (Step 3) are taken either to impose the interchange fees or not and to authorize the transaction.

If the cooperating lender clears with the licensee, then it is determined if the card has (Step 4) sufficient credit available to cover the transaction. In case there is insufficient credit available to cover the transaction, then it is determined if the cooperating lender of the card wishes to increase the credit on the account to accommodate the transaction (Step 5). If the cooperating lender does not wish to increase the credit on the account to accommodate the transaction, then it is determined if customer has authorized payment on any other account to cover the transaction (Step 6). In the absence of any such authorization by the customer, the customer is notified the inability to cover the transaction and alternatives are suggested (in Step 7).

If the customer holds a card whose cooperating lender has not negotiated acquisition of debits from the licensee, then the credit report of the customer is checked against the credit criteria of cooperating lenders who negotiated the acquisition of debits from the licensee (Step 18). If the customer satisfies criteria for at least one such cooperating lender (Step 19), then terms of the preferred cooperating lenders are disclosed to the customer and an authorization from the customer is requested (Step 19). If the customer does not satisfy the criteria of at least one of the cooperating lenders, then the customer is notified (Step 7) of the inability to pay the bills from the cooperating lenders and alternatives are suggested. The customer is suggested of some alternatives such as increasing his credit limit to cover the transaction or authorize payment on an account whose card issuer negotiated acquisition of debits from the cooperating lenders or simply authorize payment on any account that he holds.

If customer satisfies the criteria, then the customer is asked for authorization to issue bill payment from the cooperating lenders (Step 20). If the customer accepts and authorizes the bill payments by the cooperating lenders (Step 21) then the most advantageous acquisition arrangement is selected (Step 2), otherwise, the customer is notified about the inability to pay the bills and alternatives are suggested (Step 7).

If the customer has authorized payment on another account for clearing a transaction, (in Step 6), then such an arrangement is assessed for it's advantage (Step 2). When the transaction can be covered through availability of credit on account (Step 4) or the cooperating lender wishes to accommodate the transaction by increasing the credit (Step 5), then a debit is issued to the cooperating lender (in Step 9) and appropriate fees (Step 8) are imposed on the card cooperating lender. The debit is delivered to the cooperating lender (Step 9) for using the licensee account as in Step 10.

If the cooperating lender has expressed his intent to accommodate the transaction by increasing the customer's credit, then debit is delivered to the cooperating lender as in Step 9 and appropriate fees are imposed on the cooperating lender of the card as in Step 8. Additional fees are imposed on the cooperating lender for using the Licensee's account. Bills could then be paid electronically or by paper cheque (Step 15) and enquiries are made to customer about more bills to pay. In the absence of payment of any more bills, the transaction is (Step 17) reported and the enquiries are continued with the next customer.

When the cooperating lender does not clear with the licensee as in Step 11, then it is determined if the transaction can be authorized through a card database. If the transaction can be authorized through such a card database, the transaction is debited (in Step 13) and a cooperating lender's fee, including reimbursement of interchange fee, is posted to the cooperating lender (in Step 14). Bills could then be paid electronically or by paper cheque (Step 15) and enquiries are made to customer about more bills to pay. In the absence of payment of any more bills, the transaction is reported (Step 17) and the enquiries are continued with the next customer.

If the cooperating lender does not clear with the licensee and the transaction cannot be authorized (Step 11) through card database and no customer authorization on any account (Step 12) exists, then payment is denied (Step 7) and alternatives are suggested. On the contrary, if the cooperating lenders do not clear with the licensee and transaction cannot be authorized through the card database, then the transaction that is most beneficial is ascertained (Step 2).

As transactions are approved and appropriate account debited, bills are paid electronically or by paper check as in Step 15. If there are more bills to pay (Step 16), the same method is repeated, until there are no more bills to pay and a report of the transaction is made available to the customer before moving on to the next.

The invention thus allows immediate certainty of good funds through authorization and permits the customer to borrow to pay his bills. By channeling the borrowings to major cooperating lenders the invention allows a flexible management of credit limit as debits are generated. Thus these unique advantages distinguish the invention dramatically from pre-existing art.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method of paying bills by charging to a credit account, comprising the steps of:
providing a transaction delivering entity;
providing at least one participating lender;
delivering debit transactions for payment of a payor's bills to the participating lender by the transaction delivering entity without presentation of a physical card by the payor, wherein the transaction is free of transaction charges to a payee so that the payee receives full payment of an amount due, and wherein payee's consent to the transaction is unnecessary; and
managing the payor's credit line as debits are generated;
so that the payor is able to borrow on credit accounts to pay bills to any payee, without presentation of a physical card and so that channeling of borrowings to participating lenders is facilitated.

2. A method according to claim 1, wherein total debits for a payor must exceed a minimum amount, the amount specified by the participating lender.

3. A method according to claim 1, wherein characteristics of qualifying payors are specified by the participating lender.

4. A method according to claim 1 wherein the participating lender takes the transactions at par or above.

5. A method according to claim 1, wherein the participating lender pays fees to or through the delivering entity.

6. A method according to claim 1, wherein the participating borrower reimburses the transaction delivering entity for interchange fees.

7. A method according to claim 1, wherein the transaction delivering entity comprises a bill-paying service.

8. A method according to claim 7, further comprising the step of:
providing to the bill paying service by the payor at least one account to pay bills from, said account any of a deposit account, an investment account and a credit card account.

9. A method according to claim 8, further comprising the step of:
paying bills for the payor by the bill paying service.

10. A method according to claim 9, further comprising:
specifying amount paid, timing, destination, source, card account number, and accompanying information by the payor, without providing a card.

11. A method according to claim 7, wherein the bill paying service charges the payor a fee for paying the payor's bills.

12. A method according to claim 1, wherein the step of delivering debit transactions to the participating lender comprises:
obtaining authorization for each debit transaction.

13. A method according to claim 12, wherein the step of delivering debit transactions further comprises any of the steps of:
first issuing an account to the payor from the participating lender and subsequently debiting the newly issued account;
delivering debits through the credit card interchange system; and/or
delivering debits directly to the participating lender by directly interfacing with the participating lender's processing system.

14. A method according to claim 1, further comprising the step of
disbursing funds to the payee.

15. A method according to claim 1, wherein the step of managing the payor's credit line comprises:
increasing the payor's credit line without the payor requesting an increase if they have insufficient credit to cover a debit and if they meet the participating lender's standards for creditworthiness.

16. A method according to claim 1, wherein the transaction delivering entity charges a fee to the participating lender.

17. A system for payment of bills by charging to a credit account, comprising:
a transaction delivering entity;
at least one participating lender;
means for linking the participating the transaction delivering entity and the participating lenders, wherein debit transactions for payment of a payor's bills are delivered to the participating lender by the transaction delivering entity without presentation of a physical card by the payor;
means for eliminating transaction fees to payees, so that payee receives full payment of an amount due, wherein the payee's consent to the transaction is unnecessary; and
means for managing the payor's credit line as debits are generated.

18. A system according to claim 17, wherein total debits for a payor must exceed a minimum amount, the amount specified by the participating lender.

19. A system according to claim 17, the means for linking the transaction delivering entity and the participating lenders comprising one or both of:
a direct interface with the participating lender's processing system; and
an existing credit card interchange system.

20. A system according to claim 19, wherein characteristics of qualifying payors are specified by the participating lender.

21. A system according to claim 19, wherein the means for eliminating transaction fees to payees comprises an arrangement wherein the participating lender takes the transactions at par, the arrangement implemented through the interface.

22. A system according to claim 19, wherein the means for eliminating transaction fees to payees comprises an arrangement wherein the participating lender pays interchange fees for the transactions.

23. A system according to claim 19, wherein the means for eliminating transaction fees to payees comprises an arrangement wherein the participating borrower reimburses the transaction delivering entity for interchange fees.

24. A system according to claim 19, wherein the transaction delivering entity comprises a bill-paying service.

25. A system according to claim 24, wherein the payor provides to the bill paying service at least one account to pay bills from, said account any of a deposit account, an investment account and a credit card account, without presentation of a physical card.

26. A system according to claim 25, wherein the bill paying service pays bills for the payor.

27. A system according to claim 26, wherein the payor species any of: amount paid, timing, destination, source, account number, and accompanying information, without presentation of a physical card.

28. A system according to claim 26, wherein the bill paying service charges the payor a fee for paying the payor's bills.

29. A system according to claim 19, wherein the transaction delivering entity obtains an authorization for each debit transaction.

30. A system according to claim 29, wherein the participating lender issues an account to the payor and subsequently debits the newly-issued account.

31. A system according to claim 19, wherein the participating lender disburses funds to the payee.

32. A system according to claim 19, wherein the means for managing the payor's credit line comprises:
an arrangement wherein the participating lender increases the payor's credit line without the payor requesting an increase if they have insufficient credit to cover a debit and if they meet the participating lender's standards for creditworthiness, the arrangement implement over the interface.

33. A system according to claim 17, wherein the transaction delivering entity charges a fee to the participating lender.
